(19) United States
(12) Patent Application Publication
(10) Pub. No.: US 2026/0195460 A1
(43) Pub. Date: Jul. 9, 2026

(54) A Method to Assess Vulnerability of an AI Model and Framework Thereof

(71) Applicants: Robert Bosch GmbH, Stuttgart (DE); Bosch Global Software Technologies Private Limited, Bangalore (IN)

(72) Inventors: Manojkumar Somabhai Parmar, Ahmedabad, Gujarat (IN); Pavan Kulkarni, Karnataka (IN); Govindarajulu Yuvaraj, Bengaluru, Karnataka (IN)

(21) Appl. No.: 19/132,810

(22) PCT Filed: Nov. 29, 2023
(86) PCT No.: PCT/EP2023/083572

§ 371 Date: May 25, 2025

(30) Foreign Application Priority Data
Nov. 29, 2022 (IN) 2022 4106 8481

(51) Int. Cl. G06F 21/57; H04L 41/16

(52) U.S. Cl. CPC G06F 21/577; H04L 41/16; G06F 2221/033

(57) ABSTRACT

A method and a framework to assess vulnerability of an AI Model is disclosed. The framework includes the AI model, a stolen AI Model, at least one generator AI Model and at least a processor. The framework is designed to generate a uniform distribution of attack vectors across all classes of the classifier using an initial small set of pre-determined attack vectors including only a limited classes of input. The framework uses method steps to trigger attack vectors from all the output classes and test the vulnerability of the AI model against them.

### COMPLETE SPECIFICATION

The following specification describes and ascertains the nature of this invention and the manner in which it is to be performed.

### FIELD OF THE INVENTION

The present disclosure relates to the field of Artificial Intelligence security. In particular, it proposes a method of assessing vulnerability of an AI Model and a framework thereof.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The AI models in the AI systems form the core of the system. Lots of effort, resources (tangible and intangible), and knowledge goes into developing these models.

It is possible that some adversary may try to tamper/manipulate/evade the AI model to create incorrect outputs. The adversary may use different techniques to manipulate the output of the model. One of the simplest techniques used by the adversary is where the adversary sends queries to the AI system using his own test data to compute or approximate the gradients through the model. Based on these gradients, the adversary can then manipulate the input in order to manipulate the output of the Model. Another technique is wherein the adversary may manipulate the input data to bring an artificial output. This will cause hardships to the original developer of the AI in the form of business disadvantages, loss of confidential information, loss of lead time spent in development, loss of intellectual properties, loss of future revenues etc. Hence there is a need to identify samples in the test data or generate samples that can efficiently extract internal information about the working of the models and assess the vulnerability of the AI system against those sample-based queries. Hence there is a need to identify such manipulations to assess the vulnerability of the AI system.

There are methods known in the prior arts on the method of attacking an AI System. The prior art WO2021/095984 A1—Apparatus and Method for Retraining Substitute Model for Evasion Attack and Evasion attack Apparatus discloses one such method. The method talks about retraining a substitute model that partially imitates the target model by allowing the target model to misclassify for specific attack data.

However, in a classifier type AI Model there is a need to identify adversarial input of attack vectors spread across all classes and test the vulnerability of the AI Model against them.

### BRIEF DESCRIPTION OF THE ACCOMPANYING DRAWINGS

An embodiment of the invention is described with reference to the following accompanying drawings:

FIG. 1 depicts a framework for assessing vulnerability AI Model (M);

FIG. 2 depicts an AI system (10);

FIG. 2 illustrates method steps (200) of assessing vulnerability of an AI model (M).

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed and can be applied to any AI module irrespective of the AI model being executed. A person skilled in the art will also appreciate that the AI model may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. In a regression task, the model is trained based on labeled datasets, where the target labels are numeric values. Some of the typical applications of regressions are: Weather forecasting, Stock price predictions, House price estimation, energy consumption forecasting etc. Clustering or grouping is the detection of similarities in the inputs. The cluster learning techniques do not require labels to detect similarities.

As the AI module forms the core of the AI system, the module needs to be protected against attacks. AI adversarial threats can be largely categorized into model extraction attacks, inference attacks, evasion attacks, and data poisoning attacks. In poisoning attacks, the adversarial carefully inject crafted data to contaminate the training data which eventually affects the functionality of the AI system. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is a black box model attack vector where no prior knowledge of original model is required. As the prior information regarding model is available and increasing, attacker moves towards more intelligent attacks.

The attacker chooses relevant dataset at his disposal to extract model more efficiently. Our aim through this disclosure is to identify queries that give the best input/output pair needed to evade the trained model. Once the set of queries in the dataset that can efficiently evade the model are identified, we test the vulnerability of the AI system against those queries. For the purposes of this disclosure our aim to test the vulnerability of a classifier AI model against all classes of attack vectors.

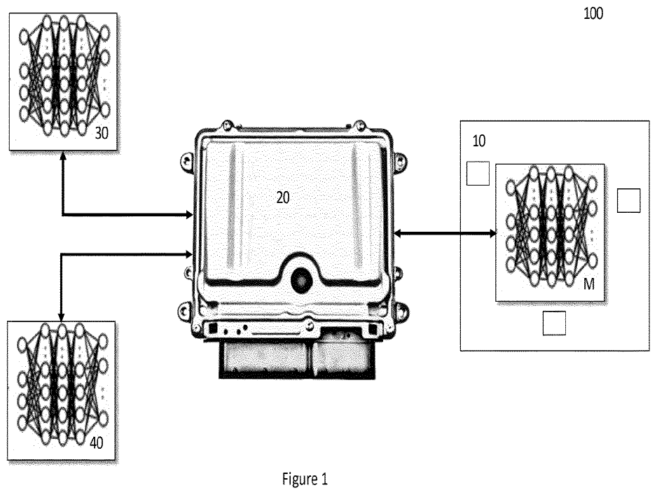

FIG. 1 depicts a framework (100) for assessing vulnerability of an AI model (M). The framework (100) comprises the AI model (M), a stolen AI Model (30), at least one generator AI Model (40) and at least a processor (20). The framework (100) is designed to generate a uniform distribution of attack vectors across all classes of the classifier using an initial small set of pre-determined attack vectors comprising only a limited classes of input.

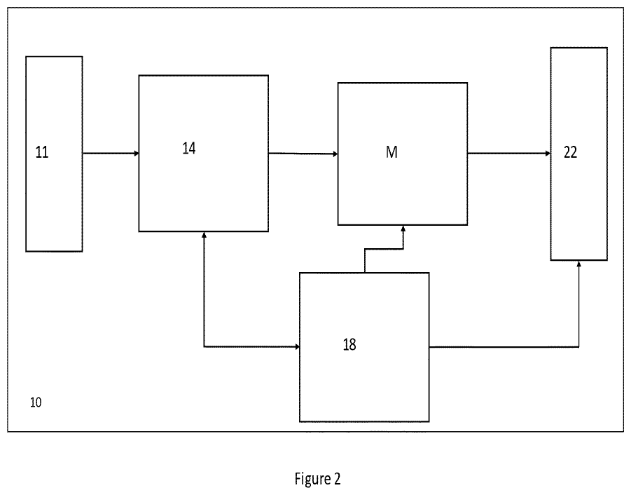

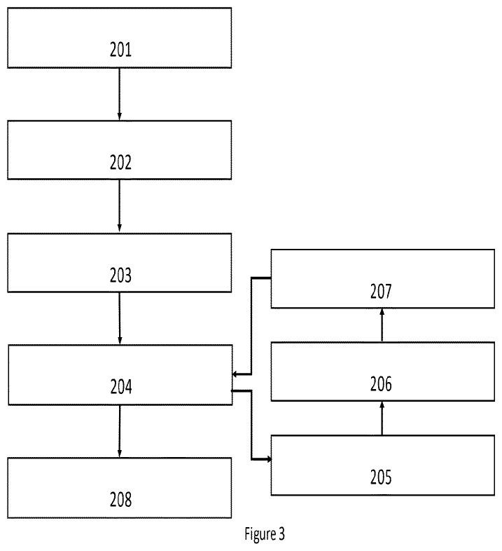

The AI model (M) is a classifier type model trained to categorize an input into a definite class. The AI model (M) is configured to process input queries and give an output by classifying the input into a particular class. FIG. 2 depicts an AI system (10). The AI model (M) could additionally be part of the AI system (10) comprising other components and modules. The AI system (10) additionally comprises an input interface (11), an output interface (22), a submodule (14) and at least a blocker module (18). The submodule (14) is trained using various techniques to identify an attack vector in the input. The blocker module (18) is configured to block a user or modify the output when an input query is determined as an attack vector. The blocker module (18) is configured to at least restrict a user of the AI system (10) in dependance of the assessment. It is further configured to modify the original output generated by the AI model (M) on identification of an input or a batch of input queries as attack vector.

As used in this application, the terms “component,” “system,” “module,” “interface,” are intended to refer to a computer-related entity or an entity related to, or that is part of, an operational apparatus with one or more specific functionalities, wherein such entities can be either hardware, a combination of hardware and software, software, or software in execution. As further yet another example, interface(s) can include input/output (I/O) components as well as associated processor, application, or Application Programming Interface (API) components. The AI system (10) could be a hardware combination of these modules or could be deployed remotely on a cloud or server. Similarly, the framework (100) could be a hardware or a software combination of these modules or could be deployed remotely on a cloud or server.

The AI model (M) is fed with a first set of pre-determined attack vectors and generates a first output. The first set of attack vectors comprise distribution of limited classes of input. For example, if the AI model is trained to classify images into 8 classes of animal, the first set of attack vectors comprise input belonging to only two classes of animals.

The stolen AI Model (30) is the reverse engineered replica of the AI model initialized by examining the input predetermined attack vectors and the corresponding first output. The generator AI Model (40) is configured to generate a second set of attack vectors. In an exemplary embodiment of the present there can be a single generator AI model (40). In an alternate embodiment of the present invention there is a set of multiple generator AI Model working in parallel. The generator AI Model (40) is deployed in an adversarial framework (100) wherein it is pitted against the parallel processing AI model and the stolen model. The AI model and the stolen model act a discriminator to the generator AI Model (40).

Generally, the processor (20) may be implemented as any or a combination of: one or more microchips or integrated circuits interconnected using a parent board, hardwired logic, software stored by a memory device and executed by a microprocessor (20), firmware, an application specific integrated circuit (ASIC), and/or a field programmable gate array (FPGA). The processor (20) is configured to exchange and manage the processing of various AI models in the framework (100) i.e. namely the AI model (M), the stolen AI Model (30) and the generator AI Model (40).

The processor (20) is configured to: feed a first set of pre-determined attack vectors to the AI Model (M) to generate a first output; initialize a stolen AI Model (30) by examining the input predetermined attack vectors and the corresponding first output; analyze the input-output pairs of the stolen model to compute metric loss for classes; feed the computed metric loss for classes to a generator AI Model (40); feed a second set of attack vectors yielded by the generator model as input to the stolen AI Model (30) and the AI model (M) to generate a second and a third output respectively; compare the second and the third output to compute a second loss function; input the computed loss as feedback to the generator AI Model (40) to improve the accuracy of the second set of attack vectors; feed the second set of attack vectors to the AI Model (M) to assess the vulnerability of the AI Model (M). The processor (20) also stores the second set of attack vectors in a database.

It should be understood at the outset that, although exemplary embodiments are illustrated in the figures and described below, the present disclosure should in no way be limited to the exemplary implementations and techniques illustrated in the drawings and described below.

FIG. 3 illustrates method steps of assessing vulnerability of an AI model (M). The framework (100) used to assess vulnerability of the AI model (M) has been explained in accordance with FIG. 1 and FIG. 2.

Method step 201 comprises feeding a first set of pre-determined attack vectors to the AI Model (M) to generate a first output by means of a processor (20). This first set of pre-determined attack vectors comprise distribution of limited classes of input. The first set of attack vectors are fetched from a database comprising identified attack vector. In an embodiment of the present invention such databases resides inside the processor (20). In another embodiment, the processor (20) is configured to retrieve information from this remotely located database.

Method step 202 comprises initializing a stolen AI Model (30) by examining the input predetermined attack vectors and the corresponding first output. Using the first set of attack vectors fed to the AI model and the corresponding out generated by it, a learnt-labelled dataset is created. This learnt labeled dataset is used to create a replica of the AI model using the model extraction technique as elucidated above. However this stolen model would not be precise as the learnt labelled dataset doesn't contain all the classes.

Method step 203 comprises analyzing the input-output pairs of the stolen model to compute metric loss for classes by means of the processor (20). This metric loss is a distance measure equation that defines difference between the estimated and true values. This difference is used to improve the results by estimating the inaccuracy of predictions. The metric is configured to produce a loss that is high for classes that are not triggered and the classes with samples less than the threshold. All the classes are not triggered or there is a significant class-imbalance. The output classes are said to be imbalanced if the number of samples of one class is significantly (lower than threshold) larger/smaller than the other classes. Computing the metric loss takes into account the class imbalance and data distribution for the various classes.

Method step 204 comprises executing at least one generator AI Model (40) using the computed metric loss for classes to generate a second set of attack vectors. In an alternate embodiment of the present invention, there may be multiple generator AI models working in parallel. Classes that were not triggered or least triggered based on the computed metric loss are created using the generator. The generator is pitted against the combination of the stolen AI Model (30) and the AI model (M) so as to create all classes of attack vectors with precision after multiple iterations. For example, when the generator AI model(s) (40) work on input as images, the Generator produces images so as to reduce the loss between the combination of the stolen AI Model (30) and the AI model (M) and maximize the difference between the images that are generated. Using these two combinations, the Generator is able to trigger new classes, which are not previously triggered through manual methods. This method step 204 is therefore repeatedly continuously until the second loss inputted via the method step (207) is negligible.

Method step 205 comprises feeding the second set of attack vectors to the stolen AI Model (30) and the AI model (M) to generate a second and a third output respectively. Method step 206 comprises comparing the second and the third output to compute a second loss function by means of the processor (20). The second loss is NOT the same as the first loss. The second loss is the output loss used to analyze the performance of the AI Model (M). For Example, if accuracy is used as the loss metric for the AI Model (M)-Output of M with respect to the ground Truth. Then the same loss would be used here to compare the results between Stolen AI Model (30) and AI Model (M).

Method step 207 comprises inputting the computed loss as feedback to the generator AI Model (40) to improve the accuracy of the second set of attack vectors.

Method step 208 feeding the second set of attack vectors to the AI Model to assess the vulnerability of the AI Model. Further, the second set of attack vectors are stored in a database by the processor (20).

The reason for using this framework (100) is that attack vectors from the attack-DB might not trigger all the output classes and might create class-imbalance.

For a robust defense mechanism of the AI model in an AI system (10), it is expected that a component of the AI system (10) recognizes majority of the attack vectors belonging to the different classes. Thereafter the blocker module (18) of the AI system (10) is supposed to block a user or modify the output when a batch of input queries is determined as an attack vector. Hence, while assessing the vulnerability of the AI Model, we record the output of the AI system (10), the processor (20) determines percentage and severity of the modified output to assess the vulnerability of the AI system (10).

It must be understood that the embodiments explained in the above detailed description are only illustrative and do not limit the scope of this invention. Any modification the framework (100) and adaptation of the method assessing vulnerability of an AI model are envisaged and form a part of this invention. The scope of this invention is limited only by the claims.

1. A method of assessing vulnerability of an AI model, said AI model being trained to classify an input into multiple classes, the method comprising:
feeding a first set of pre-determined attack vectors to the AI Model to generate a first output by means way of a processor;
initializing a stolen AI Model by examining the input predetermined attack vectors and the corresponding first output;
analyzing the input-output pairs of the stolen model to compute metric loss for classes by way of the processor;
executing at least one generator AI Model using the computed metric loss for classes to generate a second set of attack vectors;
feeding the second set of attack vectors to the stolen AI Model and the AI model to generate a second and a third output respectively;
comparing the second and the third output to compute a second loss function by way of the processor;
inputting the computed loss as feedback to the at least one generator AI Model to improve the accuracy of the second set of attack vectors; and
feeding the second set of attack vectors to the AI Model to assess the vulnerability of the AI Model.

2. The method as claimed in claim 1, wherein the first set of attack vectors comprise distribution of limited classes of input.

3. The method as claimed in claim 1, wherein the second set of attack vectors comprise distribution of all classes of input.

4. The method as claimed in claim 1, further comprising storing the second set of attack vectors in a database.

5. A framework for assessing the vulnerability of an AI Model, the framework comprising a stolen AI Model, at least one generator AI Model and at least a processor,
wherein the processor is configured to:
feed a first set of pre-determined attack vectors to the AI Model to generate a first output;
initialize a stolen AI Model by examining the input predetermined attack vectors and the corresponding first output;
analyze input-output pairs of the stolen model to compute metric loss for classes;
feed the computed metric loss for classes to the at least one generator AI Model feed a second set of attack vectors yielded by the generator model as input to the stolen AI Model and the AI model to generate a second and a third output respectively;
compare the second and the third output to compute a second loss function;
input the computed loss as feedback to the at least one generator AI Model to improve the accuracy of the second set of attack vectors; and
feed the second set of attack vectors to the AI Model to assess the vulnerability of the AI Model.

6. The framework as claimed in claim 5, wherein the first set of attack vectors comprise distribution of limited classes of input.

7. The framework as claimed in claim 5, wherein the second set of attack vectors comprise distribution of all classes of input.

8. The framework as claimed in claim 5, wherein the processor is further configured to store the second set of attack vectors in a database.
